(19) United States
(12) Patent Application Publication
(10) Pub. No.: US 2025/0118837 A1
(43) Pub. Date: Apr. 10, 2025

(54) EXPANDABLE CONDUCTIVE TAB FOR STACKED ELECTRODE BATTERY CELL

(71) Applicant: GM GLOBAL TECHNOLOGY OPERATIONS LLC, Detroit, MI (US)

(72) Inventors: Binsong Li, Troy, MI (US); Liang Xi, Northville, MI (US); SriLakshmi Katar, Troy, MI (US)

(73) Assignee: GM GLOBAL TECHNOLOGY OPERATIONS LLC, Detroit, MI (US)

(21) Appl. No.: 18/482,659

(22) Filed: Oct. 6, 2023

(51) Int. Cl. H01M 50/489; H01M 10/0525; H01M 50/536

(52) U.S. Cl. CPC H01M 50/172

(57) ABSTRACT

A battery cell includes a first electrode stack and a second electrode stack, each having at least one pair of anode and cathode elements. The cell also includes a container defining an internal chamber housing the first and second electrode stacks and having external first and second battery terminals. The cell additionally includes a first electrically conductive tab connected to the first battery terminal and to each anode element in the first and second electrode stacks and having a first expandable portion arranged between the first and second electrode stacks. The cell also includes a second electrically conductive tab connected to the second battery terminal and to each cathode element in the first and second electrode stacks and having a second expandable portion arranged between the first and second electrode stacks. The expandable portions absorb alternating expansion and contraction of the subject electrode stacks during cell charging and discharging.

### INTRODUCTION

The present disclosure relates to an expandable conductive tab for accommodating expansion and contraction of stacked electrodes in a battery cell.

Electro-chemical battery cells may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental and ease-of-use benefits compared to disposable batteries. Electro-chemical batteries may be used to power such diverse items as toys, consumer electronics, and motor vehicles.

An electro-chemical battery includes at least one anode and cathode pair sealed in a cell container. The anode and cathode electrodes are typically configured as wires or plates. The electrodes of an electro-chemical battery are typically immersed in a liquid electrolyte or separated by a solid electrolyte film that conducts ions as the battery charges or discharges. Battery cells may include one or more stacks of subject electrodes to accommodate specific power, energy, and packaging requirements. Respective anode and cathode electrodes in such stacks are generally connected by corresponding weld tabs, themselves connected to battery terminals mounted externally to the cell container. Cell containers come in various sizes and shapes-cylindrical, prismatic, and pouch cells containers are widely used.

### SUMMARY

A battery cell includes a first electrode stack and a second electrode stack, each having at least one pair of anode and cathode elements. The battery cell also includes a battery cell container defining an internal chamber configured to house the first and second electrode stacks and having externally mounted first and second battery terminals. The battery cell additionally includes a first electrically conductive tab arranged within the internal chamber, mechanically connected to the first battery terminal, and fixedly connected to each anode element in the first and second electrode stacks. The first electrically conductive tab has a first expandable portion arranged between the first and second electrode stacks. The battery cell also includes a second electrically conductive tab arranged within the internal chamber, mechanically connected to the second battery terminal, and fixedly connected to each cathode element in the first and second electrode stacks. The second electrically conductive tab has a second expandable portion arranged between the first and second electrode stacks. Each of the first and second expandable portions is configured to absorb alternating expansion and contraction of the first and second electrode stacks when the battery cell is respectively charging and discharging.

The battery cell container may be arranged along a longitudinal battery axis and constructed from one of a rigid and a pliant material.

In the embodiment of the battery cell container constructed from the rigid material, the battery cell may be either a cylindrical or a prismatic cell.

In the embodiment of the battery cell container constructed from the pliant material, the battery cell may be a pouch cell.

Each of the first and second electrically conductive tabs and each of the first and second expandable portions may be arranged parallel to the longitudinal battery axis.

Each of the first and second electrically conductive tabs and each of the first and second expandable portions may be arranged perpendicular to the longitudinal battery axis.

The battery cell may additionally include at least one spring element arranged between the first and second electrode stacks. Such spring element(s) may be configured to accommodate expansion of the first and second electrode stacks inside the battery cell container.

The battery cell may additionally include a first support plate disposed adjacent to the first electrode stack and a second support plate disposed adjacent to the second electrode stack. In such an embodiment, the spring element(s) may be arranged between the first and second support plates.

The battery cell container may have an interior surface. In such an embodiment, the first electrically conductive tab and the second electrically conductive tab may be disposed in a region of the internal chamber between the first and second electrode stacks and the interior surface. The battery cell may additionally include a separation bracket disposed in the region between the first and second electrode stacks and the interior surface to maintain separation between the first and second electrically conductive tabs.

The battery cell may be a lithium-ion cell.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of three exemplary embodiments of a battery cell, each having a corresponding cell container.

FIG. 2 is a schematic inside view of the cylindrical battery cell shown in FIG. 1, illustrating multiple electrode stacks arranged inside the respective cell container and electrically conductive tabs with expandable portions arranged between the electrode stacks, according to the disclosure.

FIG. 3 is a schematic close-up partial sectional view of the cylindrical battery cell and the electrode stacks shown in FIG. 2, illustrating an arrangement of anodes and cathodes therein, according to the disclosure.

FIG. 4 is a schematic close-up top view of a pair of anodes and cathodes shown in FIG. 3, according to the disclosure.

FIG. 5 is a schematic inside view of the prismatic battery cell shown in FIG. 1, illustrating multiple electrode stacks arranged inside the respective cell container and having electrically conductive tabs with expandable portions arranged between the electrode stacks, according to the disclosure.

FIG. 6A is a schematic perspective view of an embodiment of the prismatic battery cell shown in FIG. 1, illustrating multiple vertically arranged electrode stacks arranged inside the respective cell container and electrically conductive tabs with expandable portions arranged between the electrode stacks, according to the disclosure.

FIG. 6B is a schematic perspective view of an embodiment of the prismatic battery cell shown in FIG. 1, illustrating horizontally arranged multiple electrode stacks arranged inside the respective cell container and electrically conductive tabs with expandable portions arranged between the electrode stacks, according to the disclosure.

FIG. 7 is a schematic inside view of one embodiment of the pouch battery cell shown in FIG. 1, illustrating multiple electrode stacks arranged inside the respective cell container and electrically conductive tabs with expandable portions arranged between the electrode stacks, according to the disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

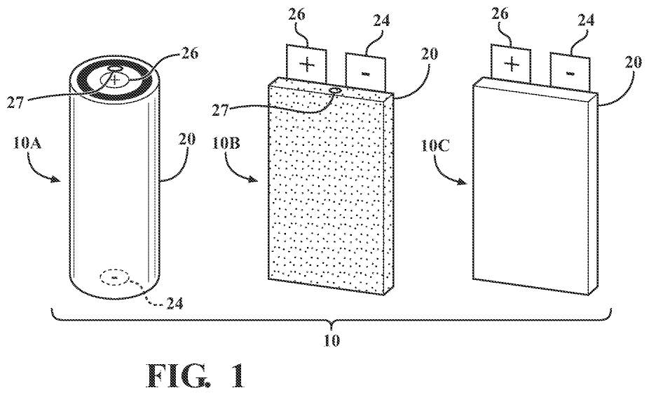

Referring to the figures, three exemplary embodiments of a battery cell 10 are depicted. Specifically, FIG. 1 depicts a cylindrical battery cell 10A, a prismatic battery cell 10B, and a pouch battery cell 10C. Generally, battery cells generate electrical energy through heat-producing electro-chemical reactions. Battery cell 10, such as the cells 10A, 10B, 10C, is configured as a secondary i.e., rechargeable, energy storage cell. The battery cell 10 may, for example, be configured as a lithium-ion (Li-ion) or a lithium metal cell. Battery cells, such as the cells 10A, 10B, 10C shown in FIG. 1 may be employed for operating toys, consumer electronics, and motor vehicles. Multiple cylindrical or prismatic cells may be grouped together in battery modules or packs for enhanced performance in specific applications.

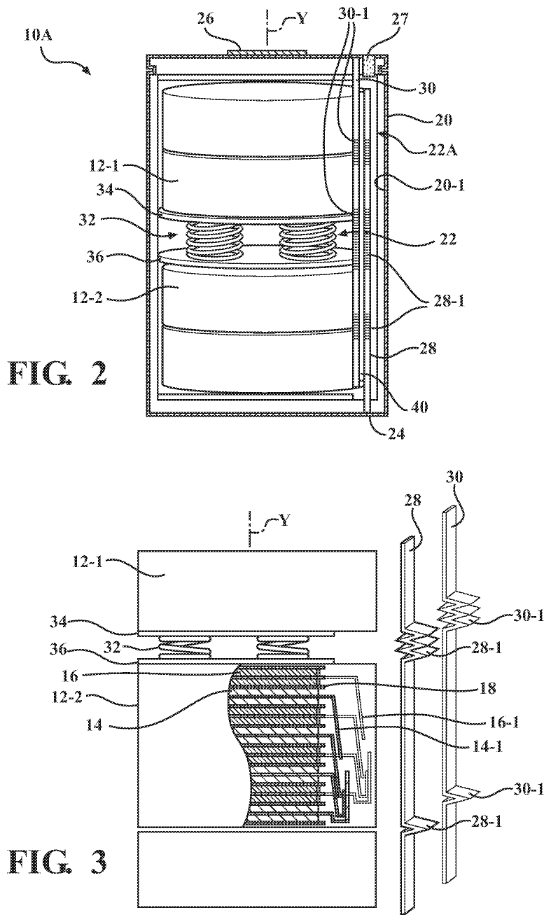

The cylindrical cell 10A generally operates like the rectangular prismatic battery cell 10B and like the pouch battery cell 10C, and the three cell types include functionally analogous internal components. As shown schematically in a cut-away state in FIG. 2, an assembled cylindrical battery cell 10A includes a plurality of electrode stacks, shown as a first stack 12-1 and a second stack 12-2. As shown in FIG. 3, each electrode stack 12-1, 12-2 includes at least one pair of alternating anode 14 and cathode 16 elements. As shown in FIG. 3, each electrode stack 12-1, 12-2 includes a separator 18 between each anode and cathode. Each separator 18 includes or holds an electrolyte formulated to conduct ions as the battery cell 10 discharges or charges. The separator 18 with electrolyte is disposed in contact with and between anode 14 and cathode 16 elements in each anode and cathode element pair such that each anode and cathode is immersed in or surrounded by the electrolyte. The battery cell 10 may use either liquid electrolyte or solid electrolyte film separating the neighboring anode 14 and cathode 16.

With resumed reference to FIG. 1, each of the embodiments of battery cell 10 also includes a cell case or container 20. Specifically, container 20 of the cylindrical battery cell 10A and the prismatic battery cell 10B may be constructed from a rigid material, typically aluminum or steel. Container 20 of the pouch battery cell 10C, on the other hand, may be constructed from a flexible or pliant material, such as aluminum laminated film made up of aluminum foil sandwiched between layers of polymers. The cell container 20 is generally sealed, e.g., via crimping, adhesive, or welding, to maintain volatile and reactive species within the respective battery cell 10 during charge/discharge cycling, and to prevent moisture, which is detrimental to the cell's performance, from entering the cell. The container 20 is generally arranged along a longitudinal battery axis Y and defines an internal chamber 22 configured to house the first and second electrode stacks 12-1, 12-2.

As shown in FIG. 1, the container 20 includes an externally mounted first or negative battery terminal 24 and an externally mounted second or positive battery terminal 26 for establishing an electrical connection between the subject battery cell and an external load. For example, as may be seen with respect to the cylindrical battery cell 10A, the negative and positive battery terminals 24, 26 may be arranged at opposite sides or ends of container 20 (e.g., one terminal at the top and the other at the bottom of the respective container when the cell is arranged upright in a module). Alternatively, as may be seen with respect to the prismatic and pouch battery cells 10B, 10C, the negative and positive battery terminals 24, 26 may be arranged adjacent to one another on the same side or on opposite sides of container 20. As such, the battery cell 10 may have top, top and bottom, or side-mounted battery terminals 24, 26. The container 20 may also include a vent 27.

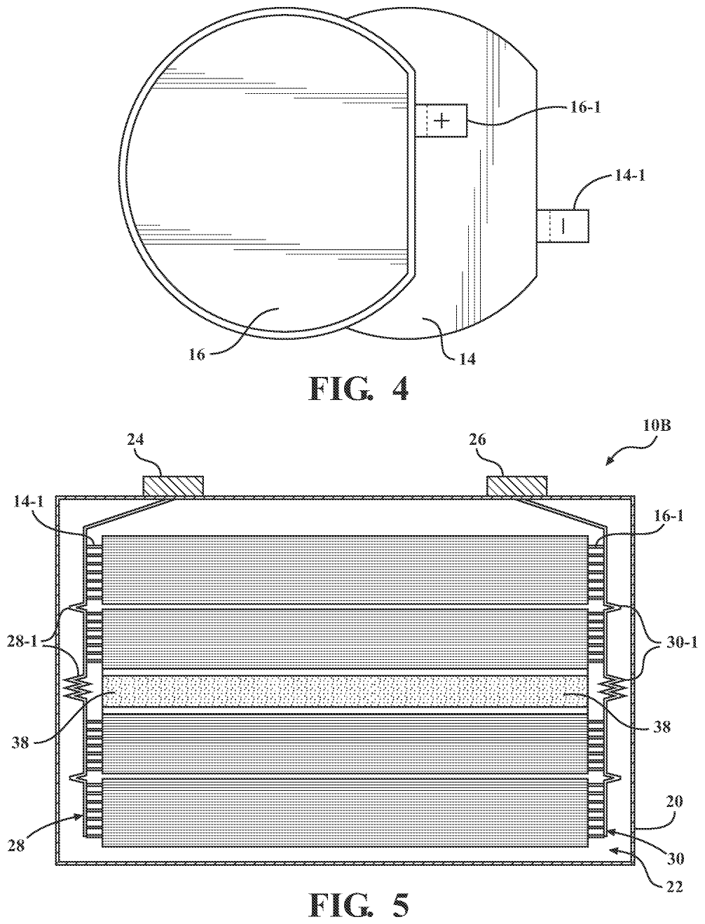

As shown in FIG. 3, battery cell 10 also includes a first electrically conductive weld tab 28 arranged within the internal chamber 22. The first weld tab 28 is mechanically connected (typically welded) to the first battery terminal 24 and is fixedly connected to each anode element 14 in the first and second electrode stacks 12-1, 12-2. The battery cell 10 additionally includes a second electrically conductive weld tab 30 arranged within the internal chamber 22. The second weld tab 30 is mechanically connected (similarly, typically welded) to the second battery terminal 26 and is fixedly connected to each cathode element 16 in the first and second electrode stacks 12-1, 12-2. As shown in FIG. 4, each anode element 14 may have a corresponding negative tab 14-1 and each cathode element 16 may have a corresponding positive tab 16-1. As shown in FIG. 3, the negative tabs 14-1 and positive tabs 16-1 may be folded and welded to corresponding first and second weld tabs 28, 30. As a result, each anode 14 will be in continuous electrical contact with the negative terminal 24, while each cathode 16 will be in continuous electrical contact with the positive terminal 26.

With continued reference to FIG. 3, the first weld tab 28 includes a first expandable portion 28-1 arranged between the first and second electrode stacks 12-1, 12-2. Similarly, the second weld tab 30 includes a second expandable portion 30-1 arranged between the first and second electrode stacks 12-1, 12-2. Each of the first and second expandable portions 28-1, 30-1 is configured to absorb alternating expansion and contraction of the first and second electrode stacks 12-1, 12-2, when the battery cell 10 is respectively charging and discharging. The expansion and contraction of the first and second electrode stacks 12-1, 12-2 occurs primarily due to volume variation of the constituent anode elements 14. As shown in FIGS. 3, 5, 6A, 6B, and 7, each of the expandable portions 28-1, 30-1 may be configured as an accordion or a corrugated section of the respective weld tab 28, 30 configured to selectively extend and compress to accommodate expansion and contraction of the first and second electrode stacks 12-1, 12-2.

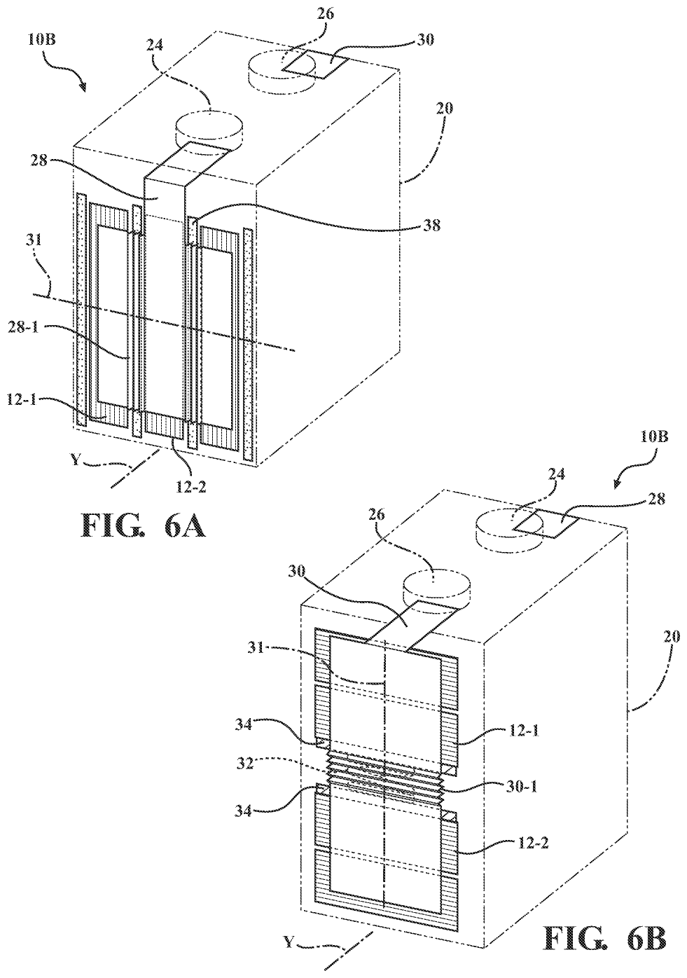

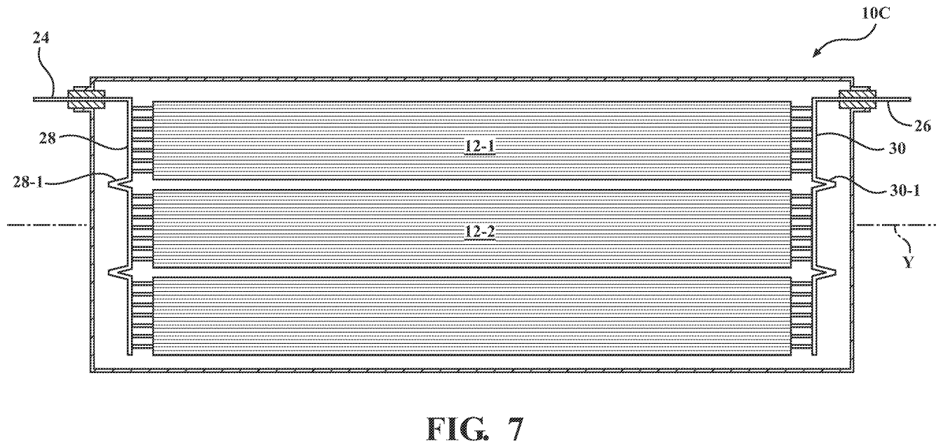

Each of the first and second weld tabs 28, 30 and each of the first and second expandable portions 28-1, 30-1 may be arranged parallel to the longitudinal battery axis Y, such as in the cylindrical and prismatic battery cells 10A, 10B with electrode stacks 12-1, 12-2 positioned along the axis Y (shown in FIG. 2). Alternatively, each of the first and second expandable portions 28-1, 30-1 may be arranged perpendicular to the longitudinal battery axis Y, such as in the prismatic and pouch battery cells 10B, 10C with electrode stacks 12-1, 12-2 positioned in a plane orthogonal to the axis Y (shown in FIGS. 6A and 6B). In other words, the first and second weld tabs 28, 30 may be arranged in the battery cell container 20 along a stack axis 31 extending in the direction of extension and contraction of the expandable portions 28-1, 30-1 (shown in FIGS. 6A and 6B). A specific embodiment of the pouch cell 10C is shown in FIG. 7, illustrating the arrangement of the electrically conductive tabs 28, 30 between the electrode stacks, relative to side-mounted negative and positive terminals 24, 26 and to the longitudinal battery axis Y.

As shown in FIGS. 2 and 6B, one or more spring elements 32 may be arranged between the first and second electrode stacks 12-1, 12-2. The spring element(s) 32 are intended to accommodate expansion of the first and second electrode stacks 12-1, 12-2 inside the battery cell container 20. Additionally, the battery cell 10 may include a first support plate 34 disposed adjacent to the first electrode stack 12-1 and a second support plate 36 disposed adjacent to the second electrode stack 12-2. The spring element(s) 32 may be arranged between the first and second support plates 34, 36. Alternatively or additionally, the battery cell 10 may include foam elements 38 arranged between electrode stacks 12-1, 12-2 (shown in FIGS. 5 and 6A). Larger first and second expandable portions 28-1, 30-1 may be used to accommodate expansion and contraction of the spring or foam element(s) 32, 38. Specifically, as shown in FIGS. 3 and 5, the first and second expandable portions 28-1, 30-1 may be configured to provide greater elongation near the spring or foam element(s) 32, 38, as compared to areas between stacks 12-1, 12-2 without such intervening elements.

With resumed reference to FIG. 2, the battery cell container 20 has an interior surface 20-1 facing the internal chamber 22. The first conductive weld tab 28 and the second conductive weld tab 30 may be disposed in a region 22A of the internal chamber 22 between the first and second electrode stacks 12-1, 12-2 and the interior surface 20-1. The battery cell 10 may additionally include a separation bracket 40. As shown in FIG. 2, the separation bracket 40 is disposed in the region 22A and configured to prevent cell short circuit by maintaining separation and preventing accidental contact between the first weld tab 28 and the second weld tab 30. The separation bracket 40 may be constructed from an electrically insulating material such as a heat and chemically resistant polymer or a coated metal.

In summary, battery cells with multiple electrode stacks packaged in a single container may experience alternating expansion and contraction of the subject electrode stacks during charging and discharging. The disclosed battery cell 10 is equipped with separate electrically conductive weld tabs for anodes and cathodes in the electrode stacks, The weld tabs are mechanically and electrically connected to respective negative and positive battery terminals and have expandable portions arranged between the respective electrode stacks. The expandable portions of the weld tabs are intended to absorb the expansion and contraction of the electrode stacks during battery cell cycling. The battery cell may have a cylindrical, prismatic, or pouch cell structure, while the cell container may be constructed from either a rigid or a flexible material. Each such battery cell configuration may accommodate the weld tabs with expandable portions.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery cell comprising:
a first electrode stack and a second electrode stack, each having at least one pair of anode and cathode elements;
a battery cell container defining an internal chamber configured to house the first and second electrode stacks and having externally mounted first and second battery terminals;
a first electrically conductive tab arranged within the internal chamber, mechanically connected to the first battery terminal, fixedly connected to each anode element in the first and second electrode stacks, and having a first expandable portion arranged between the first and second electrode stacks; and
a second electrically conductive tab arranged within the internal chamber, mechanically connected to the second battery terminal, fixedly connected to each cathode element in the first and second electrode stacks, and having a second expandable portion arranged between the first and second electrode stacks;
wherein each of the first and second expandable portions is configured to absorb alternating expansion and contraction of the first and second electrode stacks when the battery cell is respectively charging and discharging.

2. The battery cell of claim 1, wherein the battery cell container is arranged along a longitudinal battery axis and constructed from one of a rigid and a pliant material.

3. The battery cell of claim 2, wherein the battery cell container is constructed from the rigid material and the battery cell is one of a cylindrical and prismatic cell.

4. The battery cell of claim 2, wherein the battery cell container is constructed from the pliant material and the battery cell is a pouch cell.

5. The battery cell of claim 2, wherein each of the first and second electrically conductive tabs and each of the first and second expandable portions is arranged parallel to the longitudinal battery axis.

6. The battery cell of claim 2, wherein each of the first and second electrically conductive tabs and each of the first and second expandable portions is arranged perpendicular to the longitudinal battery axis.

7. The battery cell of claim 1, further comprising at least one spring element arranged between the first and second electrode stacks and configured to accommodate expansion of the first and second electrode stacks inside the battery cell container.

8. The battery cell of claim 7, further comprising a first support plate disposed adjacent to the first electrode stack and a second support plate disposed adjacent to the second electrode stack, and wherein the at least one spring element is arranged between the first and second support plates.

9. The battery cell of claim 1, wherein the battery cell container has an interior surface, and wherein the first electrically conductive tab and the second electrically conductive tab are disposed in a region of the internal chamber between the first and second electrode stacks and the interior surface, the battery cell further comprising a separation bracket disposed in the region between the first and second electrode stacks and the interior surface and configured to maintain separation between the first electrically conductive tab and the second electrically conductive tab.

10. The battery cell of claim 1, wherein the battery cell is a lithium-ion cell.

11. A lithium-ion battery cell comprising:
a first electrode stack and a second electrode stack, each having at least one pair of anode and cathode elements;
a battery cell container defining an internal chamber configured to house the first and second electrode stacks and having externally mounted first and second battery terminals;
a first electrically conductive tab arranged within the internal chamber, mechanically connected to the first battery terminal, fixedly connected to each anode element in the first and second electrode stacks, and having a first expandable portion arranged between the first and second electrode stacks; and
a second electrically conductive tab arranged within the internal chamber, mechanically connected to the second battery terminal, fixedly connected to each cathode element in the first and second electrode stacks, and having a second expandable portion arranged between the first and second electrode stacks;
wherein each of the first and second expandable portions is configured to absorb alternating expansion and contraction of the first and second electrode stacks when the battery cell is respectively charging and discharging.

12. The lithium-ion battery cell of claim 11, wherein the battery cell container is arranged along a longitudinal battery axis and constructed from one of a rigid and a pliant material.

13. The lithium-ion battery cell of claim 12, wherein the battery cell container is constructed from the rigid material and the battery cell is one of a cylindrical and prismatic cell.

14. The lithium-ion battery cell of claim 12, wherein the battery cell container is constructed from the pliant material and the battery cell is a pouch cell.

15. The lithium-ion battery cell of claim 12, wherein each of the first and second electrically conductive tabs and each of the first and second expandable portions is arranged parallel to the longitudinal battery axis.

16. The lithium-ion battery cell of claim 12, wherein each of the first and second electrically conductive tabs and each of the first and second expandable portions is arranged perpendicular to the longitudinal battery axis.

17. The lithium-ion battery cell of claim 11, further comprising at least one spring element arranged between the first and second electrode stacks and configured to accommodate expansion of the first and second electrode stacks inside the battery cell container.

18. The lithium-ion battery cell of claim 17, further comprising a first support plate disposed adjacent to the first electrode stack and a second support plate disposed adjacent to the second electrode stack, and wherein the at least one spring element is arranged between the first and second support plates.

19. The lithium-ion battery cell of claim 11, wherein the battery cell container has an interior surface, and wherein the first electrically conductive tab and the second electrically conductive tab are disposed in a region of the internal chamber between the first and second electrode stacks and the interior surface, the battery cell further comprising a separation bracket disposed in the region between the first and second electrode stacks and the interior surface and configured to maintain separation between the first electrically conductive tab and the second electrically conductive tab.

20. A lithium-ion battery cell comprising:
a first electrode stack and a second electrode stack, each having at least one pair of anode and cathode elements;
a battery cell container arranged along a longitudinal battery axis and defining an internal chamber configured to house the first and second electrode stacks and having externally mounted first and second battery terminals;
a first electrically conductive tab arranged within the internal chamber, mechanically connected to the first battery terminal, fixedly connected to each anode element in the first and second electrode stacks, and having a first expandable portion arranged between the first and second electrode stacks;
a second electrically conductive tab arranged within the internal chamber, mechanically connected to the second battery terminal, fixedly connected to each cathode element in the first and second electrode stacks, and having a second expandable portion arranged between the first and second electrode stacks;
wherein each of the first and second expandable portions is configured to absorb alternating expansion and contraction of the first and second electrode stacks when the battery cell is respectively charging and discharging;
at least one spring element arranged between the first and second electrode stacks and configured to accommodate expansion of the first and second electrode stacks inside the battery cell container; and
a first support plate disposed adjacent to the first electrode stack and a second support plate disposed adjacent to the second electrode stack, and wherein the at least one spring element is arranged between the first and second support plates.
